(19) United States
(12) Patent Application Publication
(10) Pub. No.: US 2011/0163462 A1
(43) Pub. Date: Jul. 7, 2011

(54) Universal Infrastructure for Chemical Processes

(75) Inventors: Jürgen Erwin Lang, Karlsruhe (DE); Carl-Friedrich Hoppe, Grundau (DE); Hartwig Rauleder, Rheinfelden (DE); Ekkehard Müh, Rheinfelden (DE)

(73) Assignee: EVONIK DEGUSSA GMBH, Essen (DE)

(21) Appl. No.: 13/063,171

(22) PCT Filed: May 14, 2009
(86) PCT No.: PCT/EP2009/055858

§ 371 Date: Mar. 9, 2011

(30) Foreign Application Priority Data
Sep. 10, 2008 (DE) 10 2008 041 950.8

(51) Int. Cl. C07G 99/00; G05B 1/00

(52) U.S. Cl. 260/1; 422/105

(57) ABSTRACT

The invention relates to a plant for carrying out chemical processes comprising at least means for directly carrying out the conversion in the form of means for developing products and/or in the form of at least one reactor for the continuous industrial manufacture of products, devices for receiving and/or providing starting materials and/or products and devices for controlling the conversion, which are combined to a single integrated and transportable functional unit serving as infrastructure, preferably in the form of a standardised transport container.

The invention relates to a plant for carrying out chemical processes according to the preamble of claim 1. An analogous plant is shown in EP 0 754 084 B1.

### PRIOR ART

The provision of individual modules of production plants in the form of mobile, site-independent units is known in principle from various fields of industry, for example the chemical and pharmaceutical industry, biotechnology or the like.

For example, a modular ethanol production plant made up of a plurality of modules of identical size is known from US 2008/0029447 A1. The individual modules are in each case configured as shipping containers.

A modular production plant for the production of biotechnology products is, for example, known from U.S. Pat. No. 5,656,491. The plant comprises at least two mobile modules which can be connected to one another to form a functional unit.

A transportable, modular plant for producing and utilizing biogas is known, for example, from DE 199 58 142 A1. The individual components of this plant, for example fermenters and energy part, are provided in at least two separate structural elements which are each accommodated in standard transport container frames.

Since the biochemical processes described in the abovementioned documents proceed at low pressures and temperatures, the plants described for these do not have to meet any stringent safety requirements.

Modular systems by means of which plants for carrying out chemical processes can be configured on a microspace scale are known in the field of microreactions technology.

Thus, the generic document EP 0 754 084 B1 describes a modular chemical reaction system built up on the basis of an assembly slab serving as infrastructure. All plant parts are configured as functional modules which can be combined with one another; for mass transfer between the units, the assembly slab provides integrated flow paths.

WO 01/89681 A2 likewise describes a modular system for configuring microreaction plants. The apparatuses connected to form the plant are designed as unitized functional modules which have standardized dimensions and are inserted into a mounting frame. The mounting frame has no integrated flow paths; rather, the interfaces of the apparatus are organized so that the respective inlets and/outlets of the modules located next to one another in the mounting frame adjoin one another so as to allow direct mass transfer between the modules.

Both the abovementioned modular systems are designed only for a plant capacity on the micro scale. Owing to the small throughputs and large wall thicknesses, microreaction technology makes it possible to control dangerous reactions of hazardous materials at high temperatures and pressures. In practice, such microreaction plants have the dimensions of a piece of furniture so that they can be erected in a laboratory. The safety facilities required, for example extinguishing unit, air extraction or protection of ground water and also energy supply are provided by the overall systems of the laboratory building. Owing to the low risk posed by reactions on the microspace scale, the capability of the safety infrastructure usually provided in laboratories is sufficient. For this reason, modular systems are used for microreaction plants without dedicated safety facilities.

An in-principle disadvantage of microreaction technology is the low production capacity of the microplant compared to a traditional large-scale chemical plant.

### PROBLEM

In the light of this prior art, the present invention addresses the problem of developing a plant of the type mentioned at the outset so as to make it possible to carry out chemical reactions in a production quantity going beyond the laboratory scale while maintaining strict safety precautions.

### SOLUTION

This problem is solved by a plant as claimed in claim 1. Preferred developments of the invention are described in the dependent claims.

The invention accordingly provides a plant for carrying out chemical processes,
a) having at least one device for receiving and/or providing starting materials,
b) having at least one device for receiving and/or providing products,
c) having at least one reactor for conversion of the starting materials into products;
d) and having at least one device for controlling and/or regulating the conversion,
e) where the plant is built on the basis of an infrastructure;
f) where the infrastructure provides integrated conduits by means of which material and/or energy and/or information can be exchanged between the devices and/or between the reactor and the devices,
g) where the infrastructure is provided with at least one mounting area in which devices and/or reactors and/or auxiliary apparatuses mentioned can be fixed,
h) where the infrastructure is transportable,
i) where the infrastructure confines at least one walk-in space,
k) where the mounting area is arranged in said space,
l) and where the infrastructure has an extinguishing agent distribution.

A basic concept of the present invention is to locate the infrastructure, on the basis of which the plant is built, physically within a volume into which a human being can walk but which still can be transported with a low logistical outlay and at the same time to integrate the required safety devices such as an extinguishing agent distribution into the infrastructure. An infrastructure of the type provided by the invention is therefore independent of a superordinated safety system and therefore does not have to be installed in a laboratory environment.

Since the infrastructure can be standardized independently of the processes carried out therein, the same infrastructure can be used for a variety of plants. This reduces capital costs and at the same time increases the quality. For this reason, the infrastructure as such is also an object of the invention.

A particular advantage of the plant according to the invention is that, thanks to its universal infrastructure, it can be used for several product development phases; thus, at the commencement of development of any chemical process there is a laboratory phase in which process steps and parameters are evaluated for small throughputs in discontinuous processes. Here, the chemistry of the desired process is of central interest. The development then moves on the pilot plant phase in which engineering aspects are examined. At throughputs which have been increased compared to the laboratory but are still small, a continuous process using apparatuses which correspond in terms of their function to those of a future full-scale plant is established. This is followed by the “scale-up” in which the process developed in the pilot plant is brought to the production scale. Similarity problems routinely have to be solved here.

These three phases can be carried out on the basis of the same infrastructure: It serves initially as laboratory. The devices for receiving and/or providing starting materials and products and the reactor are therefore configured on a laboratory scale. The measurements from the laboratory reaction are collected in the device for measurement/control/regulation. The infrastructure then serves as pilot plant. The laboratory devices are replaced by small apparatuses which correspond in terms of function to large-scale apparatuses. The device for measurement/control/regulation is utilized further for this purpose and continues to collect data which correspond to the learning process in the pilot plant. Finally, the infrastructure serves as basis for a large-scale plant. For this purpose, the apparatuses can be enlarged in respect of their capacity, but this leads to similarity problems. As an alternative, the plant is simply mirrored by a second infrastructure equipped in an identical manner which is provided alongside. The data acquired are likewise mirrored so that due to parallelisation one has not to worry about similarity problems.

The invention therefore also provides a process for producing products using a plant as discussed here, which has the following steps:
a) producing a first amount of products over a first period of time with recording information necessary for controlling or regulating the reaction in the reactor in the device for control or regulation of the reaction;
b) increasing the capacity of the plant while retaining the infrastructure and the device for control or regulation of the reaction;
c) producing a second amount of products over a second period of time with reading out information necessary for controlling or regulating the reaction in the reactor from the device for control or regulation of the reaction;
   where the second amount is greater than the first amount and the second period of time is after the first period of time.

The infrastructure is thus an integrated solution both for the development and continuous production of chemical products including the functions of supply and disposal of starting materials, by-products and end products, control/regulation/air conditioning.

The extinguishing agent distribution preferably allows the distribution of extinguishing agent in said space, which also has the mounting area for the plant components. If a fire occurs here, it can be extinguished by means of the extinguishing agent distribution.

The extinguishing agent distribution can likewise comprise a ring conduit circumferential to the infrastructure which has a plurality of nozzles arranged at a distance from one another for spraying the plant with liquid. If the fire bursts from the space, the entire plant can be sprayed with an extinguishing agent so that the fire cannot encroach upon the surroundings of the infrastructure.

The infrastructure preferably has at least one extinguishing agent connector which can be accessed from the outside and can feed extinguishing agent into the extinguishing agent distribution. The arriving fire brigade therefore only needs to feed an extinguishing agent into the burning infrastructure and does not have to assemble additional extinguishing equipment. This increases the speed of extinguishing.

To permit reactions involving toxic gases to be carried out in the space of the infrastructure, the latter is preferably provided with forced ventilation.

Should the ambient air be harmful for the reaction in the space, said space has to be devised to be hermetically sealed.

The space of the infrastructure can be underlaid with a collection pan to protect the ground water from leaking liquids.

The mounting area advantageously has a plurality of adaptors for accommodating said devices and/or said reactors and/or auxiliary apparatuses. This facilitates installation of the plant parts.

In a particularly preferred embodiment of the mounting area, the adaptors thereof each have the shape of a regular hexagon and these hexagonal adaptors are arranged adjacent to one another wall-to-wall in a honeycomb-like manner. In this way, the devices can be located in a particularly space-saving manner in the mounting area and the conduits can be kept short. This increases the accuracy of regulation of the plant, since only small dead times occur.

A higher degree of integration can be achieved by the infrastructure having two mounting areas which extend orthogonally to one another in the space mentioned. As a consequence, the apparatuses can be arranged next to one another in three dimensions, which saves space and conduit paths.

To simplify the installation of the plant in the surroundings, the infrastructure has at least one outward-facing interface for introducing or discharging energy and/or an auxiliary medium and/or a by-product.

To make the plant easy to transport by available transport means, the infrastructure should have the format of a standard container, in particular a container in accordance with ISO 668.

In a further variant according to the invention, means for carrying out the reaction, means of controlling the reaction and means for receiving and/or providing starting materials and/or products are arranged in different spaces of a single transport container which preferably has standard dimensions.

The infrastructure as transportable functional unit preferably comprises at least one workup space, at least one storage space and at least one instrumentation space. Starting material containers, product containers, by-product containers and the like can be kept in stock in the storage space. In the case of a particularly high capacity of the plant, the feedstock vessels close to the process can be accommodated there.

In the reaction/work-up space, the actual apparatuses for carrying out the process and for the work-up can be provided.

The plant according to the invention particularly preferably forms a completely closed functional unit, particularly when carrying out the reaction, except for the required interfaces for electric energy, inflowing air and exhaust air and the like.

In an advantageous variant of the plant according to the invention, at least one lock through which the functional unit or plant can be accessed is provided.

Particularly when air- and moisture-sensitive starting materials are to be worked up or when particularly air- and moisture-sensitive products are to be produced, it can be advantageous to provide the plant with forced ventilation. The work-up space can, for example, be actively ventilated with air, and the atmosphere can be monitored by means of conventional sensors in respect of the maximum workplace concentration of particular substances and for explosion protection.

The instrumentation space (I&C space) encompasses apparatuses for process control and process shutdown, which are separately installed there. These include, in particular, the process control systems and other electrical instruments. These are devices for controlling and/or regulating the reaction in the sense of the invention.

The circuit boxes required for the instrumentation and control can be tiled in a known manner. Preferably however, it is proposed that the arrangement and shape of the circuit boxes be in the form of a honeycomb. However, depending on the technical requirements of the process being carried out in each case and the associated technical accessories, it is also possible to provide classical circuit boxes having a cuboidal or circular shape.

In a preferred variant of the plant according to the invention, at least the storage space is underlaid with a collection pan. Of course, the entire functional unit can be underlaid with a collection pan. It is possible to provide, for example, one or more liquid sensors in the collection pan, which trigger an acoustic and/or optical alarm or effect a shutdown of the plant when liquids accumulate in the collection pan.

The storage space is advantageously provided with at least one rolling shutter gate. Rolling shutter gates can be provided without exceptional space requirement and allow free access to the storage space if need be, for example from the outside.

Apart from the fact that rolling shutter gates require relatively little space, they can also be opened and closed comparatively easily, i.e. in the sense of low operating forces.

In an advantageous embodiment of the plant according to the invention, at least one central extinguishing agent connector and at least one extinguishing agent distribution to individual spaces are provided.

In a preferred embodiment, a pipe can be provided as “semistationary extinguishing conduit”. This allows in case of damage to quickly inertise the system without hazard to the environment and the fire fighters themselves. For this purpose, it is possible to use all known extinguishing media such as CO₂, nitrogen, pulverized Aerosils, Sipernats or the like. As an alternative to an extinguishing agent distributor, individual spaces can also be equipped separately with extinguishing conduit connectors from the outside. This allows to introduce different extinguishing agents into different spaces as needed. For example, it may be necessary to use water instead of CO₂ as extinguishing agent in one of the spaces. For example, it can be necessary to use powder or foam as extinguishing agent in the instrumentation space instead of water or CO₂.

In addition, it is possible, for example, to provide a ring conduit which is arranged in the roof area of the transport container and has nozzles arranged at a distance from one another. In this way, the entire plant can be sprayed with liquid if necessary. Cooling of the plant by spraying or trickling liquid over it from the outside can also be effected in this way.

Preferably all spaces of the plant or all spaces of the functional unit can be individually hermetically sealed. For this purpose, doors which have electrical door contacts and close automatically in the case of fire are provided.

The plant is advantageously provided with at least one connector for auxiliary media. Possible auxiliary media are water, gas, steam, compressed air, nitrogen, electric power or the like.

For introduction of auxiliary media, at least one pipe bundle accessible from the outside (utility bus) can be provided. This reduces the number of necessary interfaces to the outside, increases the degree of integration and improves mobility.

### EXAMPLES

The invention will now be illustrated with the aid of examples. For this purpose:

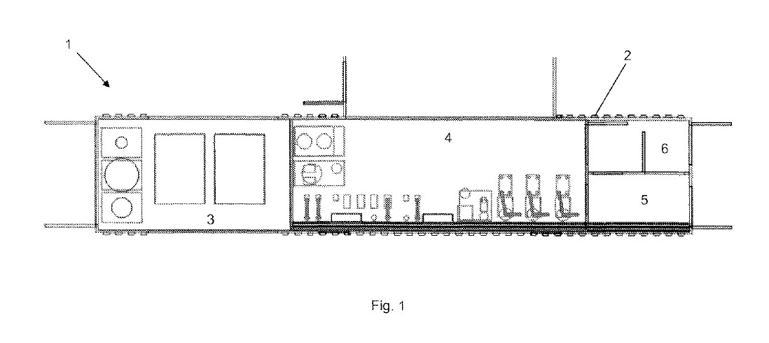

FIG. 1 shows a floor plan of a plant according to the invention.

FIG. 1 shows the floor plan of a plant 1 according to the invention which is integrated completely into an infrastructure in the form of a standard overseas transport container 2 having a length of 40 feet (13 m), a width of about 2.4 meters and a height of about 2.9 meters. This corresponds to the standard ISO 668.

The plant 1 is, as can be seen from the floor plan, divided into various spaces and comprises, for the example described, a storage space 3, a work-up space 4, an instrumentation space 5 (I&S space) and a lock 6. The entire plant can be operated in an explosion protection zone. The lock 6 makes it possible to enter the plant 1 without the process operated therein having to be shut down. All spaces are hermetically sealed by means of doors. The lock 6 can consequently be entered from the outside while the doors to the work-up space 4 and to the control space 5 are closed. After closing the exterior doors, the doors to the work-up space and/or to the instrumentation space 6 can be opened if desired. All doors are provided with door contacts so that, for example, in the case of simultaneous opening of doors of the lock 6 and the work-up space 4, automatic shutdown of the plant can be carried out.

Starting material or by-product containers, for example, are located in the storage space 3. These are devices for receiving and/or providing starting materials. The containers are preferably arranged on balances to allow monitoring of the fill level or to determine the emptying or filling mass flow by differential balancing. Optical displays for the balances are provided on the walls of the storage space.

To allow simple replacement of the containers provided in the storage space 3, this storage space 3 can be opened from the outside with a rolling shutter gate provided for this purpose, even during operation of the plant 1. The rolling shutter gate can be operated either electrically or pneumatically.

The walls of the storage space 3 and the other walls of the plant 1 are preferably configured as fire protection barriers. The floor of the control room is equipped with a pan which meets the requirements of the water conservation law and has a volume such that it can collect the amount of liquid in the largest storage container. Liquid sensors, which indicate leakage of the storage container or the plant, trigger an alarm and if necessary shut down the plant, are located in the pan. Furthermore, fire protection sensors, gas sensors and a plant shutdown and/or emergency shutdown switch are provided in the storage space.

Air conditioning of the complete plant is advantageously achieved with cooling or heating coils mounted below the ceiling. These are advantageously configured as transversely finned tubes and are connected to a cooling water circuit. As an alternative, one or more air conditioning modules can be provided.

The storage space 3, like all other spaces, is in each case connected to an extinguishing conduit.

Both means for developing chemical products and means for mass production of such products can be provided in the work-up space 4. These are reactors for converting the starting materials into products, reactor heating, feedstock vessels, heat exchangers, vaporizers, condensers, quenching stages, thermostats for supply of cooling/heating media, apparatuses for work-up/purification/materials separation, for example distillation columns, pumps, vacuum pumps, etc. In addition, the work-up space 4 is provided with the necessary pipes with fittings. These include temperature, pressure, liquid level and flow measurement devices, regulating valves, magnetic valves, drive motors, etc. These are (auxiliary) apparatuses in the sense of the invention.

The appropriate instrumentation is arranged in control cabinets which, in a preferred variant, are distributed in the work-up space 4. However, they can also be provided in the separate instrumentation space 5. The instrumentation is, for the present purposes, a device for controlling and/or regulating the reaction.

The process apparatuses provided in the work-up space 4 are connected to the storage containers of the storage space 3 via pipes which pass through the walls of the plant 1 and are preferably configured as metal pipes. These are conduits integrated into the infrastructure by means of which materials and/or energy and/or information can be exchanged between the devices and/or between the devices and the reactor.

All spaces of the plant can have frameworks which partly brace the walls in a skeleton-like fashion and to which electrical components, storage containers, process apparatuses and the like can be affixed in such a way that the system as a whole can be transported.

The framework components used for this purpose can, for example, be configured as metal hollow profiles which can serve both for reinforcing the plant and also for attachment of components and for guiding and distributing conduits and pipes.

The hollow profiles can, for example, be provided with a standardized internal thread pattern so that various devices can be fastened thereto in a simple manner. The hollow profiles represent a mounting area in the sense of the invention.

Electric and pneumatic conduits are preferably protected and screened in appropriate cable channels provided for this purpose. Apparatuses and instruments in the work-up space 4 do not have to be explosion-protected since the work-up space 4 can be hermetically sealed and ventilated in a forced manner.

In the walls between the spaces of the plant 1, it is possible to provide windows which allow observation, for example of the work-up space 4 from the instrumentation space 5.

To illuminate the spaces of the plant 1, electronic lighting means, preferably in the form of high-performance light-emitting diodes, are provided. These allow firstly energy-efficient provision of light and secondly homogeneous illumination of all spaces. In addition, these lighting means allow simple adherence to occupational hygiene guidelines. In addition to normal illumination, emergency illumination is provided, which is, for example, integrated into the ceiling of the transport container.

The ventilation of the work-up space is configured as forced ventilation from the outside. For this purpose, air is fed in from an air supply system. As an alternative, if no high explosion protection requirements have to be met, the air is aspirated and blown in with fans. It is likewise possible to connect the work-up space 4 to, for example, the instrumentation space 5 for ventilation purposes.

As mentioned above, the plant is supplied with auxiliary media such as electric power, water, nitrogen, compressed air, etc., via a bundled pipe connector provided on the outside of the transport container. This is an outward-facing interface for the introduction of energy or an auxiliary medium or a by-product. This can be conveyed from there to the work-up space 4 where the auxiliary media can be received at a distributor station. The pipes required for this purpose can, for example, be conducted at a mezzanine level over the collection pan.

The offgas streams from the individual spaces can be combined via a collective duct and discharged together. In addition, means of purifying the offgas, for example a gas scrubber and/or a fine dust filter, can be provided. The purified offgas can be discharged via a stack provided on the roof of the transport container. The stack is an outward-facing interface for removal of energy and/or an auxiliary medium and/or a by-product in the sense of the invention.

If circuit boxes are provided in the work-up space 4, these are blanketed or flushed with dry compressed air to prevent penetration of corrosive gases into the circuit boxes in the event of leakage in the work-up space 4. This allows a possible fire due to electrical malfunctions to be detected early. The flushing stream of compressed air supplied to the circuit boxes can, for example, be conveyed via integrated fire sensors.

The instrumentation space 5 can also be provided with forced ventilation. This can be useful because of, inter alia, the cooling of the electrical equipment which may be necessary. In addition or as an alternative, an air conditioning unit integrated into the ceiling can be provided with cooling and/or heating coils.

1-14. (canceled)

15. An infrastructure for a plant for carrying out chemical processes, comprising:
a) integrated conduits by means of which material and/or energy and/or information can be exchanged between devices, wherein said devices are selected from the group consisting of:
i) devices for receiving and/or providing starting materials;
ii) devices for receiving and/or providing products;
iii) devices for controlling and/or regulating a conversion of the starting materials into products;
and/or between
iv) at least one reactor for conversion of the starting materials into products and said devices;
b) at least one mounting area in which said devices and/or reactors can be fixed;
wherein:
the infrastructure is transportable;
the infrastructure confines at least one walk-in space;
said mounting area is arranged in said walk-in space; and
the infrastructure comprises one or more structures for distributing extinguishing agent.

16. The infrastructure of claim 15, wherein said one or more structures for distributing extinguishing agent allow the distribution of extinguishing agent in said walk-in space.

17. The infrastructure of claim 15, wherein said one or more structures for distributing extinguishing agent comprise a ring conduit circumferential to the infrastructure and having a plurality of nozzles arranged at a distance from one another for spraying the plant with liquid.

18. The infrastructure of claim 15, comprising at least one extinguishing agent connector which can be accessed from the outside for feeding extinguishing agent into said one or more structures for distributing extinguishing agent.

19. The infrastructure of claim 15, wherein said walk-in space has forced ventilation.

20. The infrastructure of claim 15, wherein said walk-in space can be hermetically sealed.

21. The infrastructure of claim 15, wherein said walk-in space is underlaid with a collection pan.

22. The infrastructure of claim 15, wherein the mounting area comprises a plurality of adaptors for accommodating said devices and/or said reactors and/or auxiliary apparatuses.

23. The infrastructure of claim 22, wherein at least part of the adaptors has the shape of a regular hexagon and these hexagonal adaptors are arranged adjacent wall-to-wall in a honeycomb-like manner.

24. The infrastructure of claim 15, having two mounting areas which extend orthogonally to one another in said walk-in space.

25. The infrastructure of claim 15, having at least one outward-facing interface for the introduction or discharge of energy and/or an auxiliary medium and/or a by-product.

26. The infrastructure of claim 15, wherein said infrastructure fits into the format of a standard container.

27. The infrastructure of claim 26, wherein said container is in accordance with ISO 668.

28. A plant for carrying out chemical processes, comprising:
a) at least one device for receiving and/or providing starting materials;
b) at least one device for receiving and/or providing products;
c) at least one reactor for conversion of the starting materials into products, and
d) at least one device for controlling and/or regulating the conversion;
wherein said plant is built on the basis of the infrastructure of claim 1.

29. The plant of claim 28, wherein the extinguishing agent in said infrastructure is distributed by a ring conduit circumferential to the infrastructure and having a plurality of nozzles arranged at a distance from one another for spraying the plant with liquid.

30. The plant of claim 29, wherein the walk-in space in said infrastructure has forced ventilation.

31. The plant of claim 30, wherein said walk-in space can be hermetically sealed.

32. The plant of claim 30, wherein said walk-in space is underlaid with a collection pan.

33. The plant of claim 30, wherein the mounting area in said infrastructure comprises a plurality of adaptors for accommodating said devices and/or said reactors and/or auxiliary apparatuses.

34. A process for producing products using the plant of claim 28, comprising:
a) producing a first amount of products over a first period of time and recording information necessary for controlling or regulating the reaction in the reactor in the device for control or regulation of the reaction,
b) increasing the capacity of the plant while retaining the infrastructure and the device for control or regulation of the reaction,
c) producing a second amount of products over a second period of time, reading out information necessary for controlling or regulating the reaction in the reactor from the device for control or regulation of the reaction,
where the second amount is greater than the first amount and the second period of time is after the first period of time.
